(19) United States
(12) Patent Application Publication
(10) Pub. No.: US 2020/0089908 A1
(43) Pub. Date: Mar. 19, 2020

(54) System, Method, and Apparatus for Digitally Managing Personal Data

(71) Applicant: Medhat Faltas, Paramount, CA (US)

(72) Inventor: Medhat Faltas, Paramount, CA (US)

(21) Appl. No.: 16/131,517

(22) Filed: Sep. 14, 2018

(51) Int. Cl. G06F 21/62; G06F 21/60; H04L 9/06; H04L 9/14; H04L 9/32

(52) U.S. Cl. CPC G06F 21/6245; G06F 21/602; H04L 9/3226; H04L 9/14; H04L 9/0637

(57) ABSTRACT

A computer implemented method for digitally managing personal data comprises a data storage system and the steps of receiving a variety of digital and photographic copies of personal data, prompting manual input of certain personal data, prompting categorization of the received personal data, and permitting access to such personal data upon receipt of authenticating credentials. The personal data may be stored on a blockchain, in the cloud, or locally on a person's mobile computing device, such as a smart phone. A corresponding computer program product and computer system are also disclosed.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to personal data management and, more particularly, to a system, method, and apparatus for electronically storing and accessing comprehensive and potentially diverse personal information from a common location.

### BACKGROUND

The following is a tabulation of some prior art that presently appears relevant:

U.S. Patents

| Pat. No. | Kind Code | Issue Date | Patentee |
|---|---|---|---|
| 7,454,443 | B2 | 2008 Nov. 18 | Ram et al. |
| 9,485,221 | B2 | 2016 Nov. 1 | Balasubramanian et al. |
| 9,591,075 | B2 | 2017 Jul. 7 | Blong et al. |
| 9,613,226 | B2 | 2014 Oct. 1 | Khassanov et al. |
| 9,619,661 | B1 | 2017 Apr. 11 | Finkelstein |
| 9,785,831 | B2 | 2017 Oct. 10 | Takeda et al. |

U.S. Patent Application Publications

| Publ. Number | Kind Code | Publ. Date | Applicant |
|---|---|---|---|
| 2016/0048700 | A1 | 2016 Feb. 18 | Stansky-Heilkron |
| 2016/0380774 | A1 | 2016 Dec. 29 | Abloy |

Foreign Patent Documents

| Country Code | Publ. Number | Kind Code | Publ. Date |
|---|---|---|---|
| EP | 3,149,650 | B1 | 2018 Jul. 11 |

### Nonpatent Literature Documents

None found.

### DISCUSSION OF THE PRIOR ART

In an increasingly digitally connected world, many professional and personal activities require receipt or presentation of corroborated information about oneself. This information might include for example, one's medical histories and health records, birth certificates, government issued licenses and identifications, electronic passwords, financial records, finger prints, professional certificates and accomplishments, and other personally identifying information (collectively, “personal data”).

Unfortunately, it is typically up to the owner of the personal data to determine where and how they would like to store it. As a result, the diverse personal data tend to amass in various locations across the owner's electronic devices, such as laptop, desktop, and tablet computers as well as mobile “smart” phones. For instance, much of this data may be converted from physical to digital form, if not already available as a digital copy, and may be storable and accessible as JPEG, PDF and other digital images across various directories stored in the electronic devices. Other aspects of this data may be manually entered and saved by the owner as items in an editable list by way of various word processing systems available in the marketplace.

These methods are deficient for a number of reasons, however. For instance, many files contain sensitive information, and it may be difficult to prevent unauthorized access to one's personal data particularly where such data is stored conventionally on a shared computing device. Indeed, sometimes, conventionally stored data is not accessible remotely, which is rather inconvenient. When such data is accessible, there may be no record of whether such data has been modified, which results in various versions of modified copies of similar data being stored across multiple devices. Naturally, even when accessible, it can be confusing to determine which of the various versions contains the most accurate personal data. Additionally, it may be difficult for a recipient of another's personal data to determine the authenticity data stored according to the proposals above.

As such, there remains a need for a fully integrated system which enables electronic access to any of a variety of secured personal data from a single application.

### SUMMARY

The present disclosure is directed to systems, methods, and apparatuses that enable fully integrated management of one's own personal data from a single, secure application. For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In an embodiment, elements comprising the system, method, and apparatus for digitally managing personal data may be operative to receive data such as digital and photographic copies of one's identification cards and other data, as well as prompt a user to manually input relevant personal data, ultimately storing each of the personal datum within separated yet readily accessible categories. These categories may include, for example only and not limitation, identification; medical history such as any medical events experienced by the owner of the data as well as allergies, diseases, and the history of medication taken by the owner; ancestral or family history including where applicable birth and death certificates and even information related to one's children and/or dependents; professional history such as a comprehensive curriculum vitae; personal accomplishments; financial records; insurance records; and even a comprehensive listing of and access to one's social media accounts. In other words, it is contemplated that elements comprising embodiments of the system, method, and apparatus may enable a user to customize a digital portfolio that categorizes all of his or her critical personal data in commonly accessible, yet secure location.

The method for personal data management may be implemented by an electronic mobile device such as a smart phone, laptop, or tablet computer. Of course, other types of electronic devices, such as a desktop computer are also contemplated.

It should be noted that in some embodiments, a providing communication with a server database may enable access to one's personal data securely stored in the “cloud.” Those skilled in the art will recognize “cloud” computing as a type of internet-based computing that provides shared computer processing resources and data to computers and other devices on demand. Through the cloud, certain work-related activities, and others, may be performed via specialized applications such as office suites.

Personal data voluntarily categorized within the system according to the disclosure may be safeguarded to prevent unauthorized persons or entities from accessing a particular user's data. For instance, the elements comprising the system, method, and apparatus may prompt a user to create his or her own authentication credentials, such as a username and password. In some embodiments, the password may be a combination of alpha-numeric characters. In some embodiments, the password may be the user's fingerprint. In still other embodiments, the password may be a real-time image of the user's eyes and/or face. Of course, may passwords are possible, the foregoing are offered as non-limited examples of possible passwords.

Access to a user's personal data may be established via encrypted links between a web server over a computing network, such as a cloud computing network, and mobile software applications. One example of a security protocol applicable in some embodiments may be Secure Socets Layer (“SSL”) and others known to those having skill in the art.

In some embodiments, the personal data may be stored on a blockchain. This may be beneficial owing to the fact that it is quite difficult it is to modify records and data stored on the blockchain. In such embodiments, a private key and a public key are needed to access a particular block or blockchain data, and the private key—or authentication credential—which is unique to a user, in this case a data owner, is needed to generate a new transaction on the blockchain. If personal data, such as licenses, identifications, and certifications were stored on the blockchain, the private key of the data owner would be needed to view and/or modify the records.

In light of the foregoing, it is contemplated that a person may be enabled to conveniently manage his diverse personal data from a common location. Indeed, while commonly accessible from a single software application, this personal data may be accessed by a user submitting personalized authenticating credentials across multiple access devices.

Some non-limiting objects and advantages of the system, method, and apparatus for personal data management are as follows:

The system, method, and apparatus enable an owner of diverse types of potentially sensitive personal data to access, review, and/or amend such data from a single mobile application.

The system, method, and apparatus, separates personal data from other documents and files such as one might find dispersed throughout a traditional computing or even cloud-based file directory.

Predetermined categories or directories in the system, method, and apparatus minimize user confusion with respect to the location of their personal data.

The system, method, and apparatus provide greater security for potentially sensitive personal data which might otherwise be stored piecemeal across a variety of unsecured locations.

The system, method, and apparatus corroborate authenticity of an owner's personal data.

The system, method, and apparatus may enable access to one's personal data from multiple electronic devices.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a block diagram of a networked environment in which an exemplary embodiment of a system for personal data management is implemented.

FIG. 2 illustrates an exemplary embodiment of a mobile device shown in FIG. 1.

FIG. 3 is a flowchart depicting an exemplary embodiment of a method for personal data management.

FIG. 4 is an illustration of an exemplary user interface associated with the method for personal data management.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

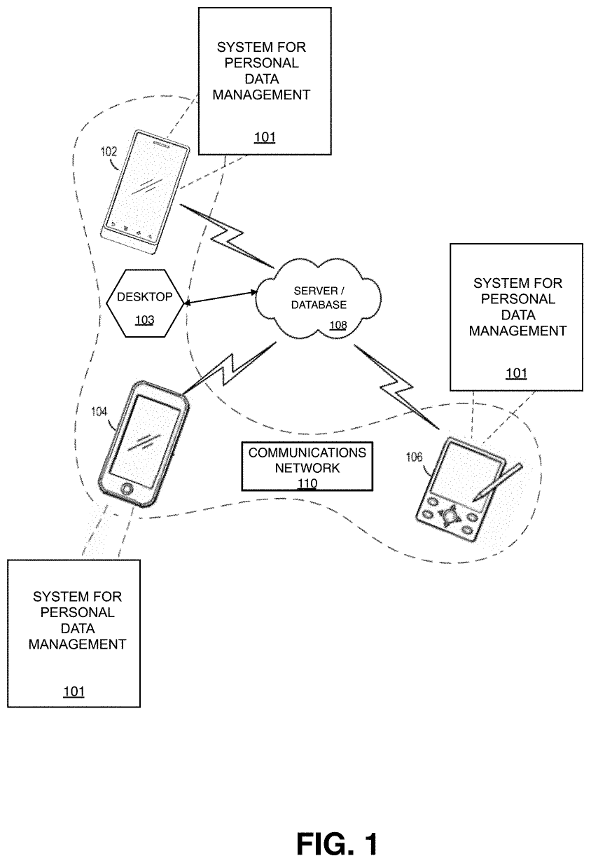

FIG. 1 illustrates an exemplary embodiment of the present invention which includes a plurality of electronic devices communicatively coupled to one another. By way of example, and not limitation, FIG. 1 illustrates mobile devices 102, 104, and 106, and desktop computer 103 that incorporate a system for personal data management 101 and are communicatively coupled via a communications network 110 and by or through server/database 108. Each of the mobile devices may be embodied as a mobile computing device such as, for example and without limitation, a smartphone or tablet computer that incorporates cellular telephone functionality. Notably, the communications network 110 can use one or more of various communications types such as, for example and without limitation, cellular and Wi-Fi communications, local area networks (LANs), wide area networks (WANs), client services, content services, and Avatar Messaging Services (AMS). In some embodiments, one or more mobile devices (not pictured) may take the place of one or more of mobile devices 102, 104, and 106, and desktop computer 103. Each of mobile devices 102, 104, and 106, and desktop computer 103 may comprise an electronic device having at least a touchscreen, a camera, a GPS location, a memory, wireless data transfer capability, and a microphone, as may be more fully discussed elsewhere herein.

Users of desktop computer 103 and mobile devices 102, 104, and 106 may be users of at least one communications network 110 known to those skilled in the art. For instance, as noted above, communications network 110 may comprise a peer-to-peer network, a cloud-based computing network, a fog computing network, a blockcloud computing network, or any other communications network 110 known in the art capable of secure data transfer. Indeed, it is contemplated that through the “cloud”, certain personal data may be remotely stored and accessed so that the personal data itself need not be physically stored on each and every mobile device 102, 104, 106 and desktop computer 103. Indeed, through the cloud, one's personal data may be retrieved at any of mobile devices 102, 104, 106 and desktop computer 103, or others not pictured.

More particularly, network 110 may be facilitated by a mobile software application or website that may require a registration and login prior to use.

In a blockchained embodiment, the present invention may be stored in multiple copies across one or more databases on one or more nodes (not pictured). In some embodiments, each node may contain and run the software, hardware, firmware, or any other component necessary, to run the present invention. More specifically, each node may provide for a computer system that can run the program of the present invention, create, store, and link (or “chain”) blocks of encrypted data to other blocks of encrypted data. In some embodiments, each block may comprise (except for the genesis block) a hash that records a timestamp representing the block's creation date and time (along with, in some embodiments, other information), encrypted data, the previous block's hash, and instructions for the linking of the second block to the present block. In some embodiments, the instructions may comprise a mathematical problem to be solved. Each node may also provide for computational power sufficient to perform hash functions, other one-way encryption functions, two-way encryption functions, public key encryption functions and programs, symmetric encryption and symmetric key encryption functions and programs, along with any other function that may be used or provided for by the present invention. In some embodiments, system for managing personal data 101 may provide that the solution is provided to one or more nodes associated with one or more databases. In some embodiments, some or all of the nodes associated with one or more databases may be equally able to solve the instructions, and therefore some or all of the nodes may discover the solution at roughly the same time, thus ensuring uniformity of record-keeping across one or more databases. Additional blocks may be created each time the encrypted data is either accessed or changed, and each new block may comprise a new timestamp hash unique to that block, the previous block's hash, encrypted data, and instructions for the next linkage-by-hash as detailed above.

In embodiments having a blockchain database backend or other comparable elements, one or more nodes (not pictured) may take the place of one or more of mobile devices 102, 104, and 106, and desktop computers 103.

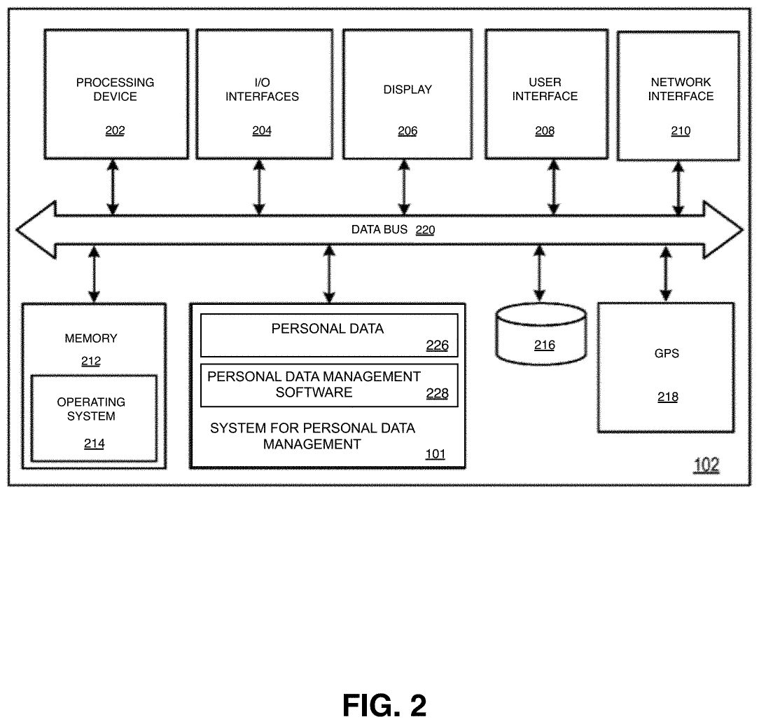

FIG. 2 illustrates at least one mobile device 102, wherein each mobile device 102 may, in some embodiments, comprise a networked computer system, and in some embodiments a blockchain system wherein within server/database 108. In some embodiments, mobile devices 102, 104, and 106, and desktop computer 103 may, in addition to their roles as either a first electronic device or a second electronic device, may alternatively or simultaneously comprise at least one mobile device 102, or one or more nodes or lightweight nodes, in blockchain embodiments.

In the embodiment depicted in FIG. 2, mobile device 102 may comprise, at least, at least one processing device (processor) 202, at least one input/output interface 204, at least one display 206, at least one user interface 208, at least one network interface 210, at least one memory 212, at least one operating system 214, at least one mass storage 216 and at least one GPS 218, with each communicating across a local data bus 220. Additionally, at least one mobile device 102 may receive and store at least one personal data point 226, though it is contemplated that it will receive many, and may run at least one personal data management software application 228.

In some embodiments, server/database 108, or even a distributed block chain computer system, may provide that each mobile device 102 may communicate with one or more mobile devices 102, and in some embodiments all other mobile devices 102. Additionally, in some embodiments, one or more elements of mobile device 102 may be absent in any particular mobile device 102 or shared across one or more mobile devices 102. By way of illustration and not limitation, the present invention may access memory 212 and/or operating system 214 stored partially or completely across several mobile devices 102.

The processing device 202 may include any custom made or commercially available processor, a central processing unit (CPU) or an auxiliary processor among several processors associated with mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 212 can include any one of a combination of volatile memory elements (e.g., random-access memory (RAM, such as DRAM, and SRAM, etc.)) and nonvolatile memory elements. The memory typically comprises native operating system 214, one or more native applications, emulation systems, or emulated applications for any of a variety of operating systems and/or emulated hardware platforms, emulated operating systems, etc. For example, the applications may include application specific software which may comprise some or all the components of mobile device 102. In accordance with such embodiments, the components are stored in memory and executed by the processing device. Note that although depicted separately in FIG. 2, the system, method, and apparatus for personal data management 100 may be resident in memory such as memory 212. As mentioned above, in some embodiments, one or more mobile devices 102 may not have their own memory 212 and/or operating system 214 or may store incomplete memory 212 and/or operating system 214, and may therefore draw upon other mobile devices 102 for use of one or more memory units 212 and/or operating system elements 214 via mobile device 102 to mobile device 102 communication 228, as discussed herein.

User interface 208 may be configured to detect contact within the display area of the display 206 and may provide such functionality as on-screen buttons, menus, keyboards, etc. that allows users to navigate user interfaces by touch. User interface 208 may also be a keyboard, a mouse, a microphone, a vision tracking system, a motion-capture system, a trackball, or any other known interface with a computing system. For some embodiments, mobile device 102 may also comprise GPS 218 or other means to determine the location of the mobile device 102.

One of ordinary skill in the art will appreciate that the operating system 214 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 2, network interface device 210 comprises various components used to transmit and/or receive data over a networked environment such as depicted in FIG. 1. When such components are embodied as an application, the one or more components may be stored on a non-transitory computer-readable medium and executed by the processing device.

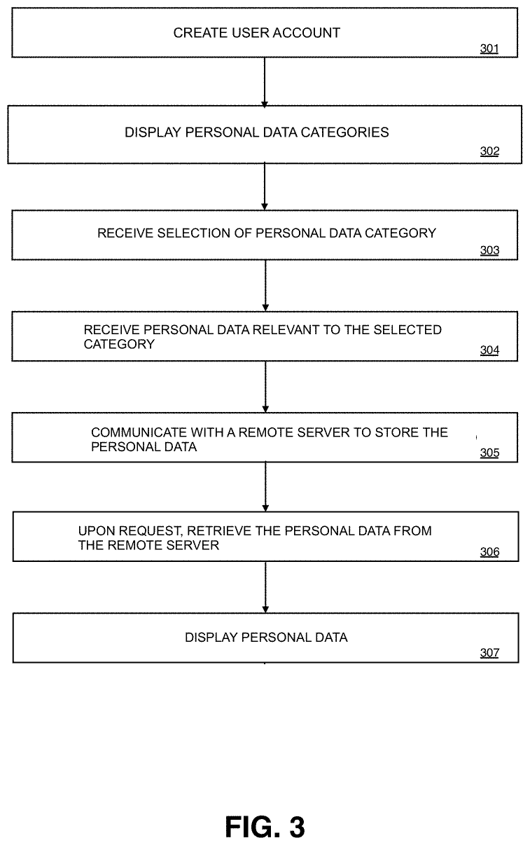

In order to facilitate the aforementioned functionality, various aspects may be performed by one or more of desktop computer 103 and/or mobile devices 102, 104, and 106, or any mobile device 102 which may be but is not limited to desktop computer 103 and/or mobile devices 102, 104, and 106. In one embodiment, the desktop 103, mobile devices 102, 104, and 106, and/or any mobile device 102 are operative to perform, at least in part, the method depicted in the flowchart of FIG. 3 and described above.

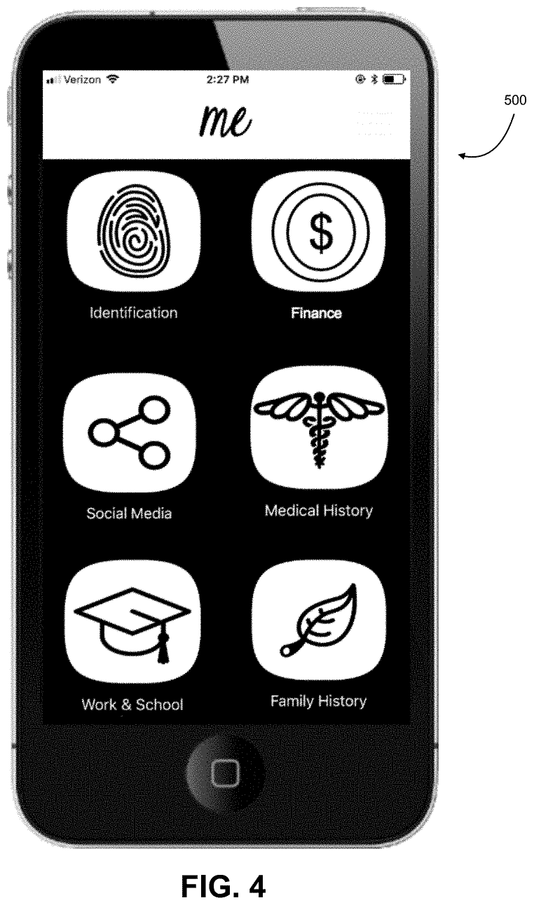

Turning attention to FIG. 3, the exemplary method for personal data management is disclosed may be implemented by an electronic mobile device, such as the mobile electronic device discussed above. First, a user may create a user account 301, which ensures that only individuals in possession of such user's authentication credentials may gain access to any personal data managed by the system. Then, responsive to verifying the authentication credentials associated with an owner of the personal data, a plurality of selectable personal data categories may be displayed 302. With reference to FIG. 4, a wireframe diagram is provided which illustrates one example, of many possibilities, of the selectable personal data categories which may be displayed. Indeed, it may be seen that such categories may be displayed on a smart phone 400 having touch screen functionality. As such, it may be possible that authentication credentials include a user's fingerprint or even facial recognition known to those of skill in the art.

In some embodiments, the personal data categories may be any of those illustrated in the exemplary user interface of FIG. 4. The exemplary identification category may comprise, for instance, personal data including digital copies of one's government issued identification cards, citizenship and/or legal entry status documents, fingerprint images, and others. The exemplary finance category may comprise a listing of one's personal financial information, including for example and not limitation, bank account numbers, comprehensive information identifying one's investments, debts, insurance information, tax history and other data, as well as any payment due dates associated with such information. The social media category may grant a user access to any of a variety of his or her social media accounts, such as Facebook®, Instagram®, LinkedIn®, Snapchat®, Tumblr® and others. The exemplary medical history category may comprise a listing of one's allergies and other health conditions, digital copies of diagnostic test results, a listing of current and past medications, and others. The exemplary work and school category may comprise personal data including one's professional certifications, curriculum vitae, résumè, and transcripts. The exemplary family history may comprise, for example, a listing of one's immediate and/or extended family members and even ancestors including their birth dates and even death dates, where applicable, and even bibliographic information about them such as their address, profession and other desirable information about them. Additional categories are, of course, contemplated. As a nonlimiting example, an accomplishments category may comprise information related to one's personal achievements such as news articles about one's self, accomplishments in the community, personal records, and many others.

In addition to the foregoing exemplary information, one may be enabled to access one's social media accounts through the secure system. It is also contemplated that one may store sensitive information such as passwords, financial information, insurance information, among others in additional categories. As such, the invention should not be limited by the number or characterization of the particular categories explicitly described. It is contemplated that a category may be generated for any personal information that may be desirable to store in a secure, centralized directory.

Returning to FIG. 3, the electronic mobile device implementing an embodiment of the method for managing personal data may further comprise receiving a selection of any of the personal data categories available 303, such as the nonlimiting examples discussed above, and then receiving personal data related to such category 304. The personal data may comprise one or more copies of personal data as previously compiled digital files, such as JPEG, PDF, or other digital files as may be known to those skilled in to the art and which comprise a user's personal data. The personal data may also comprise manual text inputs such as a listing of accomplishments, birthdates, passwords, etc. where applicable.

The method may further comprise communicating with a remote server to store the personal data 305, such as server 108 from FIG. 1. Indeed, with continued reference to FIG. 3, method may comprise retrieving stored personal data from the remote server upon request from a user 306. Then, of course, the personal data may be displayed 307.

It is contemplated that a user may instruct the electronic device to move, remove, and add personal data among and between the categories, which themselves may be recharacterized, as desired. However, in light of the foregoing, a user should be enabled to conveniently access any of his securely stored personal data as desired and without difficulty.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the appearance of the user interface, as well as particular arrangement and characterization of the personal data categories may vary as desired. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method, and apparatus for digitally managing personal data with which that terminology is associated. In general, the terms used in the following claims should not be constructed to limit the system, method, and apparatus for digitally managing personal data to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, method, and apparatus for digitally managing personal data is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, method, and apparatus for digitally managing personal data.

What is claimed is:

1. A method for personal data management implemented by an electronic mobile device, comprising:
responsive to receiving authentication credentials associated with an owner of the personal data, displaying a plurality of selectable personal data categories;
receiving one or more copies of personal data as previously compiled digital files;
receiving personal data responsive to receiving manual text inputs;
storing the personal data; and
displaying relevant personal data responsive to receiving a selection of a personal data category.

2. The method of claim 1, wherein the categories are predetermined, and the method further comprises prompting a user to select a predetermined category to assign a piece of personal datum prior to receiving such personal datum.

3. The method of claim 2, wherein the categories are defined by at least the user's personal identification, medical history, and social media accounts.

4. The method of claim 1, wherein the personal data is stored on a blockchain, the method further comprising:
receiving, by a processor of a computing system, an encrypted private key and a public key associated with an owner of the personal data stored on the electronic mobile device in control of the owner, wherein the encrypted private key is decrypted by authentication credentials known to the owner;
decrypting, by the processor, the encrypted private key using the authentication credentials known to the owner; and
accessing, by the processor, the personal data of the owner, using a combination of the public key and the private key associated with the owner, to access a storage medium containing the personal data.

5. The method of claim 2, wherein the storage medium is a blockchain database, stored in the cloud and contains personal data provided by the owner of such data.

6. A system for personal data management, comprising:
a mobile electronic device comprising processing circuitry operative to:
receive authentication credentials associated with an owner of the personal data, verify the owner's authentication credentials;
display a plurality of selectable personal data categories;
receiving one or more digital files;
receive manual text input;
communicate with a remote server to store the personal data store the personal data in relevant categories; and
responsive to receiving a selection of a personal data category, retrieve the personal data from the remote server to display relevant personal data.

7. A non-transitory, tangible computer readable medium having stored thereon computer-executable instructions, which, when executed by a computer processor, enable performance of the method comprising:
responsive to receiving authentication credentials associated with an owner of the personal data, display a plurality of selectable personal data categories;
receive one or more copies of personal data as previously compiled digital files;
receive personal data responsive to receiving manual text inputs;
communicate with a remote server to store the personal data; and
displaying relevant personal data responsive to receiving a selection of a personal data category.
